(19) United States
(12) Patent Application Publication
(10) Pub. No.: US 2002/0113721 A1
(43) Pub. Date: Aug. 22, 2002

(54) Duct attachable control apparatus

(76) Inventor: Kiyoshi Kurashita, Osaka (JP)

Correspondence Address: BIRCH STEWART KOLASCH & BIRCH, PO BOX 747, FALLS CHURCH, VA, 22040-0747, US

(21) Appl. No.: 10/066,662

(22) Filed: Feb. 6, 2002

(30) Foreign Application Priority Data
Feb. 19, 2001 (JP) 2001-041632 (P)

(51) Int. Cl. G08G 1/123

(52) U.S. Cl. 340/999; 340/990

(57) ABSTRACT

An I/O unit is attached to cover an opening of a trench type wiring duct having a bottom surface, opposing side surfaces and an upper opening and accommodating a control cable therein, the I/O unit processes control signal input to or output from the control cable, and processes control signals input to or output from the outside of the wiring duct.

### BACKGROUND OF THE INVENTION

1. Field of the Invention

The present invention relates to a duct attachable control apparatus. More specifically, the present invention relates to a duct attachable control apparatus that is attached to an opening of a wiring duct having a bottom surface, opposing side surfaces and an upper opening and accommodating control cables therein.

2. Description of the Background Art

In an apparatus for manufacturing semiconductor devices, flow rate of chemicals and cleaning liquid, electric power, pressure, temperature and the like must be controlled, and hence a large number of control units, temperature sensors and the like for analog control are arranged therein. Nearly, various apparatuses including various control units and temperature sensors are arranged in other production lines of electronic components, automobile components or food packaging lines. Such control units and sensors are controlled by a central computer. Control signals from the computer are output serially to reduce the number of cables, converted to parallel control signals by an I/O unit within such an apparatus, and various control units are controlled through a group of relays. Therefore, in the apparatuses, the computer and the various control apparatuses are connected by control cables, wiring cables and the like.

Signals from sensors in these apparatuses are transmitted through the group of relays and converted to serial signals by the I/O unit, and transmitted to the computer over the control cables.

FIG. 11 shows an appearance of a conventional DIN rail attachable I/O unit, and FIG. 12 shows the state of connection between each of wiring ducts, I/O units and a group of relays in a conventional apparatus.

Referring to FIGS. 11 and 12, control signals from a computer are transmitted serially by a control cable 101. A plurality of wiring ducts 102, 103 and 104 are provided in the apparatus, and the wiring ducts 102, 103 and 104 accommodate control cable 101 and wiring cables. Control cable 101 is connected to an I/O unit 105 such as shown in FIG. 11. I/O unit 105 converts serial control signals applied through control cable 101 to parallel control signals and output the same. The parallel control signals are applied through wiring cable 106 to the group of relays 107. The group of relays 107 is turned on/off in accordance with the control signals, and the corresponding control unit is controlled.

To the I/O unit 105, a box 108 for accommodating electronic circuit parts and connectors 109, 110 are attached.

In the conventional method of wiring shown in FIG. 12, a space is necessary for attaching I/O unit 105, and therefore, increase or change is not easy. Further, for attachment to DIN rail, it is difficult to standardize the I/O unit 105 shown in FIG. 11 as the structure is complicated. Thus, reduction of cost by standardization is not easy, either.

### SUMMARY OF THE INVENTION

Therefore, an object of the present invention is to provide a duct attachable control apparatus that can be attached to a wiring duct to enable easy addition or change, is suitable for standardization and hence enables reduction in cost.

Briefly stated, the present invention provides a control apparatus attached to a trench type wiring duct having a bottom surface, opposing side surfaces and an upper opening and accommodating control cables therein, the control apparatus including a box attached to cover the opening of the wiring duct, and a control circuit accommodated in the box and processing control signals input to /output from the control cables, and processing control signals input to /output from the outside of the wiring duct.

Therefore, according to the present invention, the space for attaching the control circuit becomes unnecessary, addition of the apparatus is easy and the apparatus is suitable for standardization, and therefore, the cost can be reduced.

The box includes a panel partially covering the opening of the wiring duct, and an accommodating portion accommodating a control circuit, provided below the panel.

The panel is provided with an indicator indicating the contents of control by the control circuit.

The accommodating portion includes a sidewall and a bottom, and includes at the bottom, a first connector provided for connection with a control cable, and a second connector for connection with a wiring cable.

Further, fitting portions to be fitted with upper portions of opposing side surfaces of the duct are provided at opposing end portions of the panel that are parallel to the duct.

Further, openings are formed on opposing side surfaces of the wiring duct, for inserting a wiring cable, over which a control signal externally output from the control circuit is transmitted.

Further, the control circuit includes a first input/output control circuit controlling input/output of a control signal to the control cable, a second input/output control circuit controlling input/output of a control signal to the wiring cable, and a conversion processing circuit converting control signals input to /output from the first and second input/output control circuits, respectively.

Further, the control cable serially transmits the control signals, and the first input/output control circuit includes a serial/parallel converting circuit for converting serial control signals to parallel signals and applying the parallel signals to the conversion processing circuit.

Further, the second input/output control circuit includes any of an input unit, an output unit, an A/D converting circuit and a D/A converting circuit.

Further, a plurality of boxes are attached spaced by a prescribed distance from each other at the opening of the wiring duct, and control circuits in respective boxes are serially connected by a control cable.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of one embodiment of the present invention.

FIG. 2 is a block diagram of the I/O unit shown in FIG. 1.

FIG. 3 shows an appearance of an example of the wiring duct.

FIG. 4 is a perspective view of the appearance of the I/O viewed from above.

FIG. 5 is a perspective view of the appearance of the I/O viewed from the back side.

FIG. 6 is a top view of the panel of the I/O unit.

FIG. 7 is a perspective view showing the I/O unit attached to the wiring duct of FIG. 3.

FIG. 8 shows an example in which a connector and the plug for use with a common wiring cable are attached to the back surface of the accommodating portion.

FIG. 9 shows the back surface of the accommodating portion with the plug removed.

FIG. 10 shows an example in which two connectors and plugs are attached to the back surface of the accommodating portion, so as to enable connection of two wiring cables.

FIG. 11 shows an appearance of a conventional I/O unit to be attached to the DIN rail.

FIG. 12 shows the manner of connection between wiring ducts, I/O units and a group of relays in the conventional apparatus.

### DESCRIPTION OF THE PREFERRED EMBODIMENTS

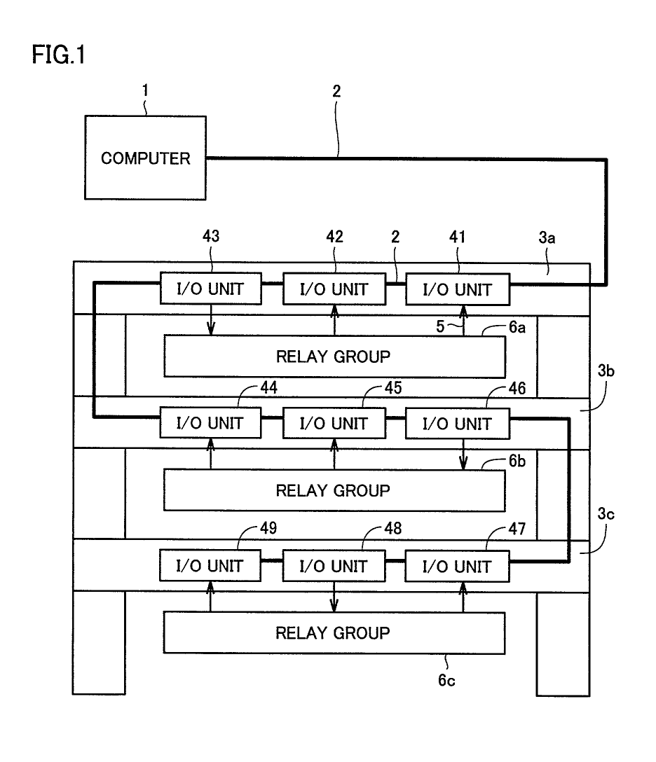

FIG. 1 shows the configuration of one embodiment of the present invention. Referring to FIG. 1, control signals from a central computer 1 are transmitted serially. In an apparatus as an object of control, wiring ducts 3a, 3b and 3c are arranged, and I/O units 41 to 49 which are the characteristics of the present invention are attached to respective ducts. I/O units 41 to 49 are connected in series by a control cable 2. I/O units 41 to 49 convert serially transmitted control signals to parallel control signals, and turn on/off relay groups 6a to 6c through wiring cables 5.

Signals from the sensors and the like are directly applied to I/O units 41 to 49 through wiring cables 5, converted to serial signals and transmitted to computer 1 over control cable 2.

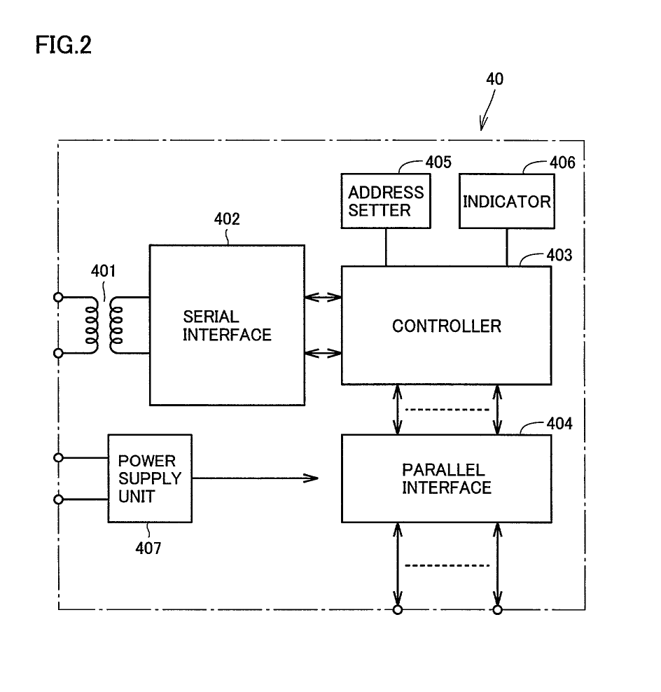

FIG. 2 is a block diagram of the I/O unit 40 shown in FIG. 1. I/O unit 40 includes a pulse transformer 401, a serial interface 402, a controller 403, a parallel interface 404, an address setter 405, an indicator 406 and a power supply unit 407.

Pulse transformer 401 outputs pulse-shaped control signals applied from control cable 2 to serial interface 402. Serial interface 402 is implemented by a serial/parallel converter, for example, that converts serial signals to parallel signals and outputs the resulting signals to controller 403. Controller 403 performs a converting process on the input control signals as needed, and outputs the control signals to parallel interface 404.

Parallel interface 404 may be an output unit for controlling relay groups 6a to 6c shown in FIG. 1, an input unit for receiving as inputs digital signals output from sensors of the apparatus, a D/A converter for converting digital data for voltage control to analog signals, or an A/D converter converting analog signals from sensors and the like to digital signals to be applied to controller 403.

Address setter 405 sets a unique address of the corresponding I/O unit 40. Indicator 406 indicates contents of the I/O, state of communication, state of power supply and the like. To the power supply unit 407, a DC power of 24 V, for example, is externally supplied, and the power supply unit supplies necessary DC voltage to various circuits. The address may be externally set through control cable 2 and, in that case, it is unnecessary to provide address setter 405.

As the I/O unit 40, an input/output terminal of a shift input/output transmission system described in Japanese Patent Laying-Open No. 5-76072, for example, may be used. In the shift input/output transmission system, a controller and a plurality of input/output terminals are connected in series by a control cable, and when a current is supplied from the controller to the control cable, the input/output terminal of the first stage outputs a current pulse to the control cable with the pulse width varied dependent on whether the corresponding sensor is in operation or not, and prevents supply of current to input/output terminals of the succeeding stages. When it is determined that an output current is provided from the controller while the current pulse is being output, the corresponding control unit is operated, and thereafter, the current is supplied from the control cable to the input/output terminals of the succeeding stages. The controller detects whether a sensor of any of the input/output terminals is in operation or not, in accordance with whether the current pulse is being transmitted to the control cable or not.

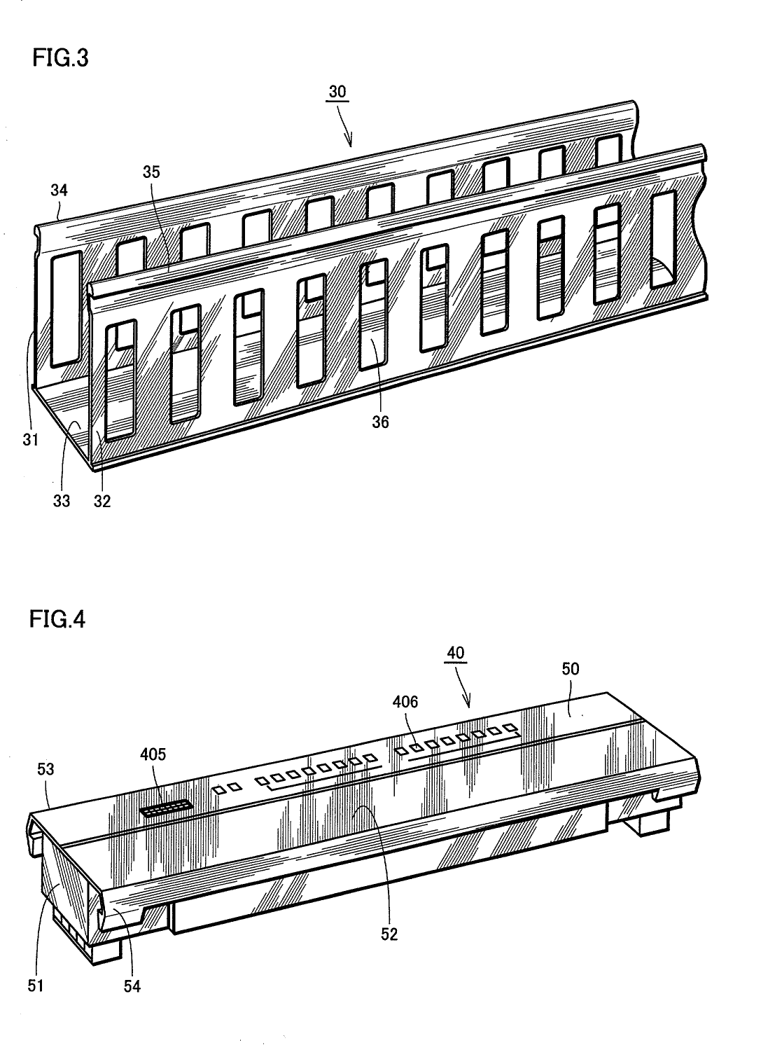

FIG. 3 is a perspective view showing the appearance of an example of the wiring duct. Wiring duct 30 is formed to have a trench-shape including sidewalls 31 and 32 and a bottom portion 33 with the upper portion opened, and it is formed by resin molding or by bending a metal plate. At end portions on the opening side of sidewalls 31 and 32, projections 34 and 35 are formed to be engaged with I/O unit, when the unit is attached. A plurality of holes 36 are formed in sidewalls 31 and 32 allowing insertion of wiring cables 5, and through the holes 36, wiring cables 5 are connected to the relay groups 6a, 6b and 6c.

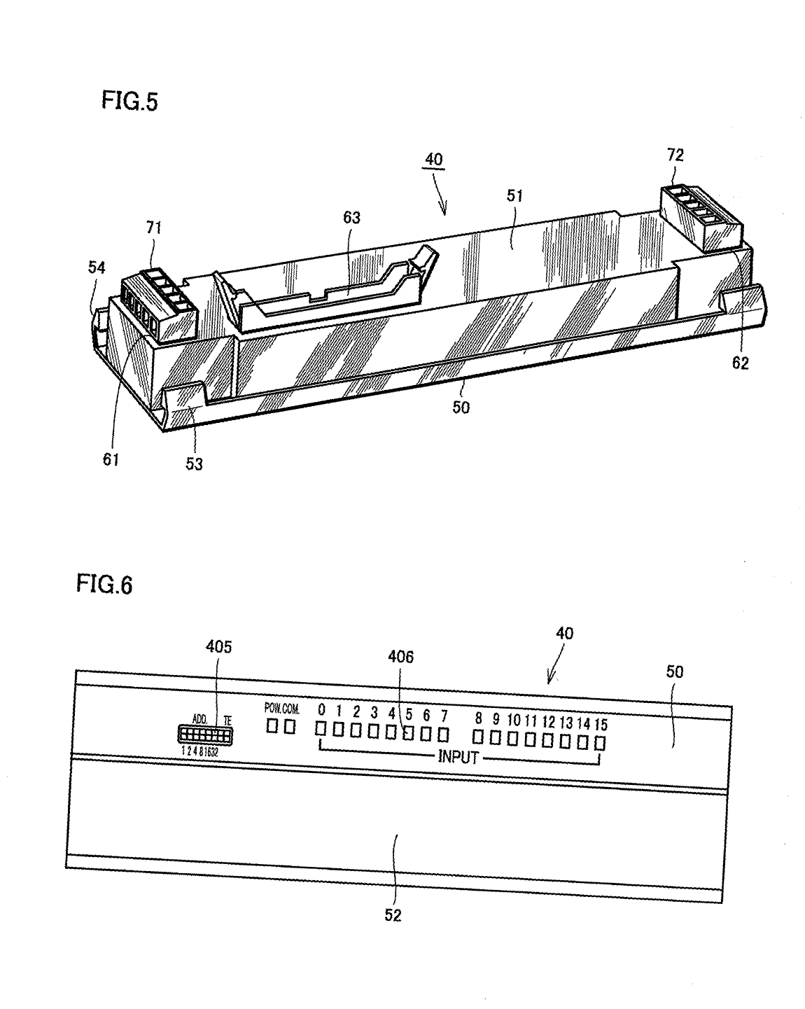

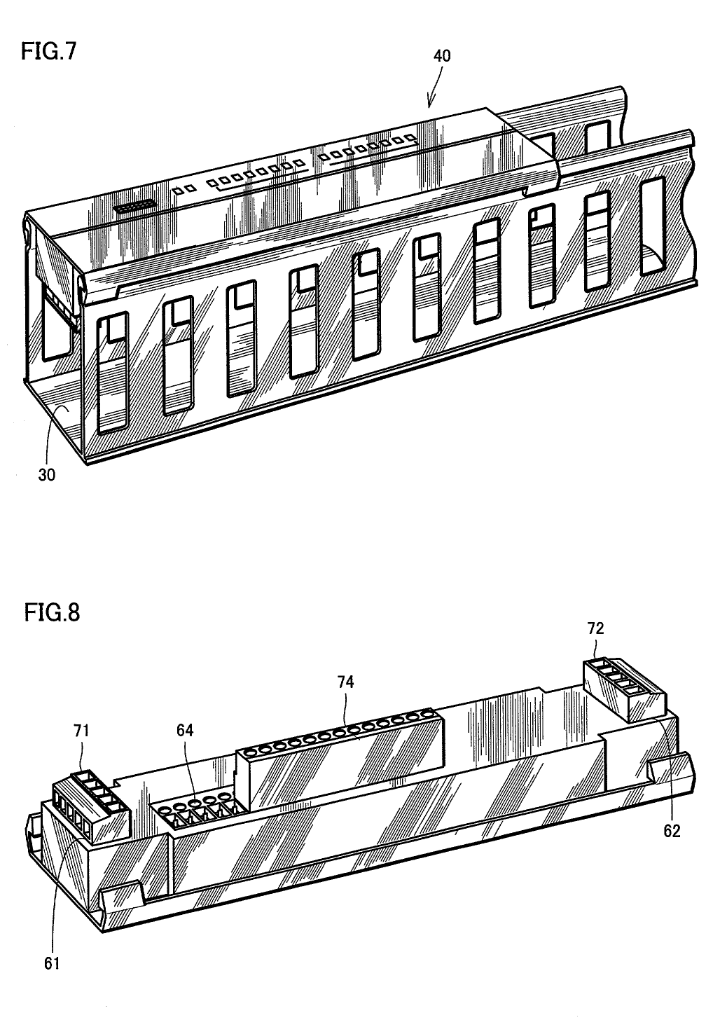

FIG. 4 is a perspective view showing the appearance of I/O unit 40 viewed from above, FIG. 5 is a perspective view showing the appearance of the I/O unit 40 viewed from the back side, FIG. 6 is a top view of the panel of the I/O unit, and FIG. 7 is a perspective view showing the appearance of I/O unit 40 attached to the wiring duct 30 shown in FIG. 3.

I/O unit 40 has a body including a panel 50 and an accommodating portion 51. On panel 50, address setter 405 and indicator 406 shown in FIG. 2 are arranged. Accommodating portion 51 has sidewalls and a bottom portion, and accommodates parallel transformer 401, serial interface 402, controller 403, parallel interface 404 and power supply unit 407. Further, there is a space 52 for attaching a plaque indicating the function of I/O unit 40 on panel 50.

Further, at ends parallel to wiring duct 30 of panel 50, fitting portions 53 and 54 are formed, to be fitted with projections 34 and 35 of wiring duct 30. As the fitting portions 53 and 54 are fit and engage with projections 34 and 35 of wiring duct 30, I/O unit 40 can be attached snapped on wiring duct 30, as shown in FIG. 7. When I/O unit 40 is to be removed from wiring duct 30, fitting portions 53 and 54 are opened outward, and I/O unit 40 is pulled upward, and the unit can be easily removed out from the wiring duct 30.

Referring to FIG. 5, at the bottom surface of accommodating portion 51 of I/O unit 40, connectors 61, 62 and 63 are attached. Connectors 61 and 62 serially connects between computer 1 and I/O unit 40 and between each of I/O units 40 through control cable 2 by means of plugs 71 and 72, respectively. Connector 63 connects I/O unit 40 to the relay group 6 by a wiring cable, such as a flat cable.

A plurality of I/O units 40 are attached spaced by a prescribed distance at the opening of wiring duct 30. The opening at which I/O unit 40 is not attached is covered by a lid, not shown.

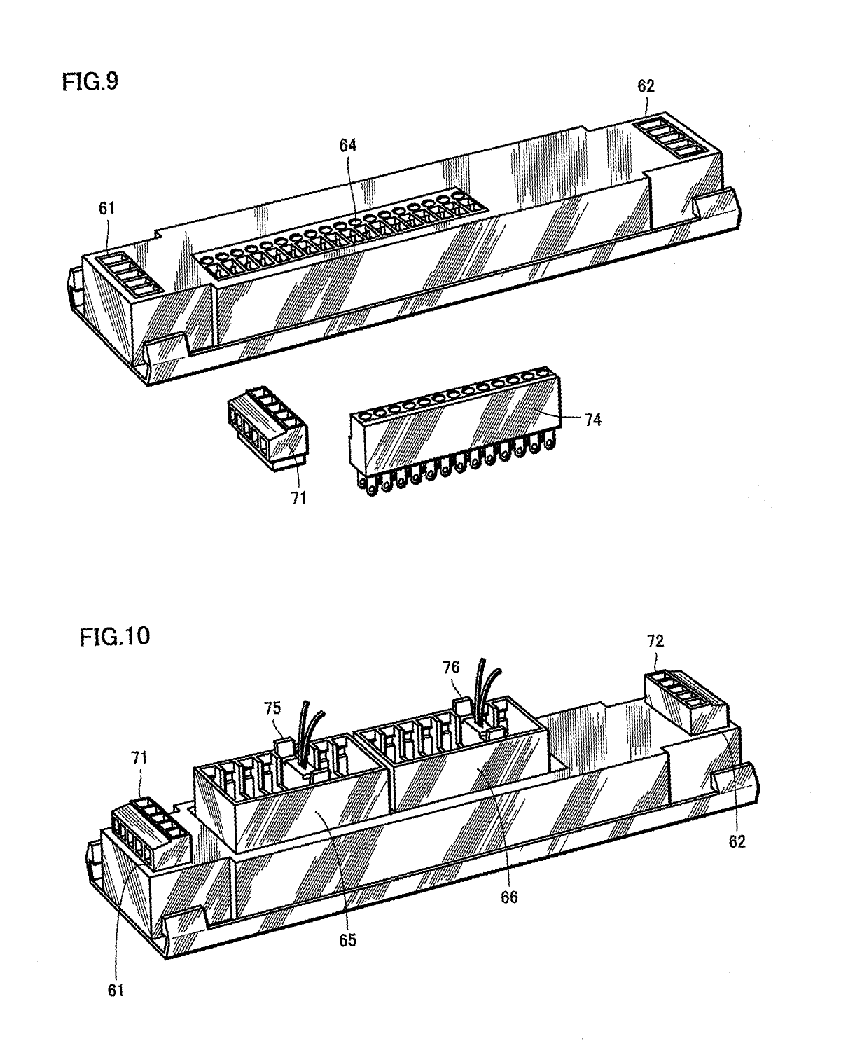

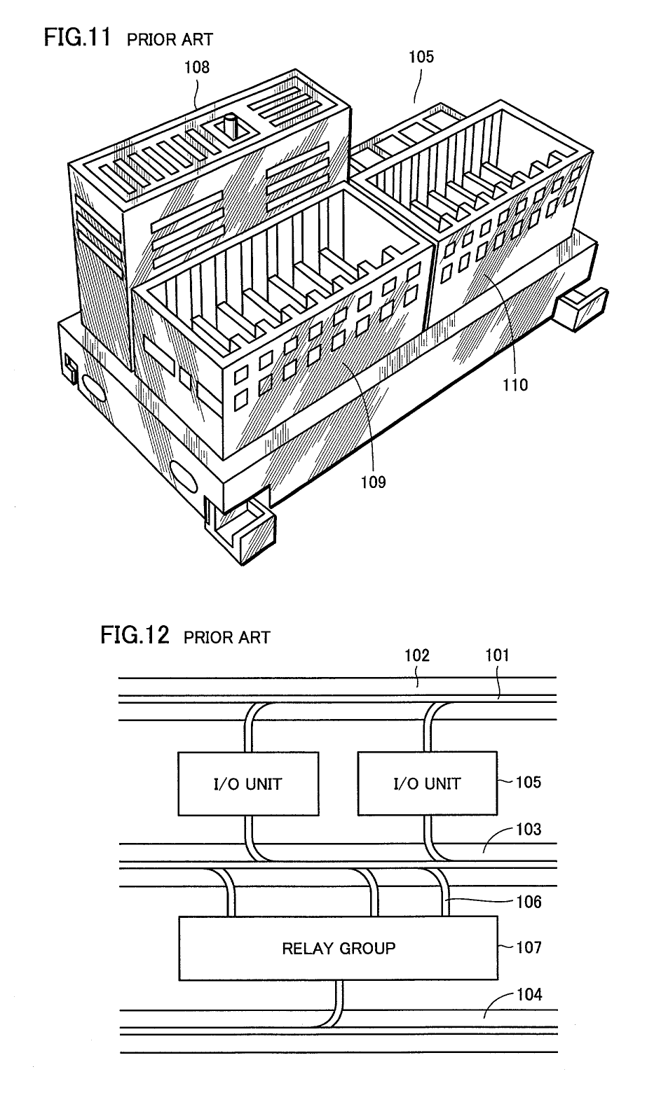

FIGS. 8 to 10 represent another example of the connector attached to the back surface of accommodating portion 51 of the I/O unit 40. In FIG. 8, a connector 64 and a plug 74 are attached for use with a common wiring cable, as the control cable, and FIG. 9 shows the state of the unit with the plug removed. FIG. 10 shows an example in which two connectors 65, 66 and two plugs 75 and 76 are attached, so that two wiring cables 5, 5 can be connected.

As described above, according to the embodiment of the present invention, a body of the control apparatus is attached to cover an opening of a trench type wiring duct having a bottom surface, opposing side surfaces and an upper opening and accommodating control cable therein, and the control apparatus processes, by a control circuit, control signals input to/output from the control cable and processes control signals input to/output from the outside of the wiring duct. Therefore, the space for attaching the control circuit can be eliminated, standardization is facilitated and the cost can be reduced.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A control apparatus attached to a trench type wiring duct having a bottom surface, opposing surfaces and an upper opening and accommodating a control cable therein, comprising:
a box attached to cover the opening of said wiring duct; and
a control circuit accommodated in said box and processing control signals input to/output from said control cable and control signals input to/output from the outside of said wiring duct.

2. The duct attachable control apparatus according to claim 1, wherein
said box includes
a panel partially covering the opening of said wiring duct, and
an accommodating portion provided below said panel and accommodating said control circuit.

3. The duct attachable control apparatus according to claim 2, wherein said panel is provided with an indicator representing contents of control by said control circuit.

4. The duct attachable control apparatus according to claim 2, wherein
said accommodating portion includes a sidewall and a bottom portion, and
said bottom portion is provided with a first connector for connecting a control cable, and a second connector for connecting said wiring cable.

5. The duct attachable control apparatus according to claim 2, wherein
fitting portions to be fitted with upper portions of opposing side surfaces of said duct are provided at opposing ends parallel to said duct of said panel.

6. The duct attachable control apparatus according to claim 1, wherein
the opposing side surfaces of said wiring duct are provided with openings for inserting a wiring cable transmitting a control signal output from/input to the outside of said control circuit.

7. The duct attachable control apparatus according to claim 6, wherein
said control circuit includes
a first input/output control circuit controlling input/output of a control signal to said control cable,
a second input/output control circuit controlling input/output of a control signal to said wiring cable, and
a conversion processing circuit converting control signals input to/output from said first and second input/output control circuits, respectively.

8. The duct attachable control apparatus according to claim 7, wherein
said control cable serially transmits control signals, and
said first input/output control circuit includes a serial/parallel converting circuit converting said serial control signals to parallel signals to be applied to said conversion processing circuit.

9. The duct attachable control apparatus according to claim 2, wherein
said second input/output control circuit includes any of an input unit, an output unit, an A/D converting circuit and a D/A converting circuit.

10. A duct attachable control apparatus according to claim 1, wherein
a plurality of said boxes are attached spaced by a prescribed distance at the opening of said wiring duct, and control circuits in respective boxes are serially connected by said control cable.
